(19) United States
(12) Patent Application Publication
(10) Pub. No.: US 2025/0284481 A1
(43) Pub. Date: Sep. 11, 2025

(54) INFORMATION PROCESSING APPARATUS, INFORMATION PROCESSING METHOD, AND NON-TRANSITORY RECORDING MEDIUM

(71) Applicant: Takuya INOUE, Kanagawa (JP)

(72) Inventor: Takuya INOUE, Kanagawa (JP)

(21) Appl. No.: 19/067,995

(22) Filed: Mar. 3, 2025

(30) Foreign Application Priority Data
Mar. 6, 2024 (JP) 2024-033698

(51) Int. Cl. G06F 8/65; G06F 3/12; G06F 8/61

(52) U.S. Cl. CPC G06F 8/65; G06F 3/1203; G06F 3/123; G06F 3/1285; G06F 8/61; G06F 8/62

(57) ABSTRACT

An information processing apparatus includes circuitry. The circuitry installs an application. The circuitry stores, in a memory, installation method information indicating an installation method with which the application is installed in association with a contract type of the application. The circuitry refers to the installation method information and the contract type to determine whether the application is permitted to be updated at a time of updating the application. The circuitry controls update of the application according to a determination result.

### CROSS-REFERENCE TO RELATED APPLICATION

This patent application is based on and claims priority pursuant to 35 U.S.C. § 119 (a) to Japanese Patent Application No. 2024-033698, filed on Mar. 6, 2024, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

In the update of an application in an information processing apparatus such as an image forming apparatus, the application is updated with an update method provided in a mechanism in which the application is installed. In the related art, when installable applications are different for installation mechanisms, a determination of whether to update a certain application may be performed by checking only the presence of the update version of the certain application in the update processing.

For example, a configuration has been proposed that automatically determines whether to install and update an application through a network in order to automatically install and update the application.

### SUMMARY

According to one aspect of the present disclosure, an information processing apparatus having an automatic application update function includes circuitry. The circuitry installs an application. The circuitry stores, in a memory, installation method information indicating an installation method with which the application is installed in association with a contract type of the application. The circuitry refers to the installation method information and the contract type to determine whether the application is permitted to be updated at a time of updating the application. The circuitry controls update of the application according to a determination result.

According to one aspect of the present disclosure, an information processing method includes installing an application on an information processing apparatus. The information processing method includes storing, in a memory, installation method information indicating an installation method with which the application is installed in association with a contract type of the application. The information processing method includes referring to the installation method information and the contract type to determine whether the application is permitted to be updated at a time of updating the application. The information processing method includes controlling update of the application according to a determination result.

According to one aspect of the present disclosure, a non-transitory recording medium stores a plurality of program codes which, when executed by a computer, causes the computer to perform a method. The method includes installing an application on an information processing apparatus. The method includes storing, in a memory, installation method information indicating an installation method with which the application is installed in association with a contract type of the application. The method includes referring to the installation method information and the contract type to determine whether the application is permitted to be updated at a time of updating the application. The method includes controlling update of the application according to a determination result.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a relationship between an image forming apparatus and servers;

FIG. 2 is a block diagram illustrating an example of the configuration of the image forming apparatus of FIG. 1;

FIG. 3A is a diagram illustrating an example of the software configuration of the image forming apparatus of FIG. 1;

FIG. 3B is a block diagram illustrating an example of the functional configuration of the image forming apparatus of FIG. 1;

FIG. 4 is a diagram for describing an example of a flow of update processing from a medium by the image forming apparatus of FIG. 1;

FIG. 5 is a diagram for describing an example of a flow of firm update processing by the image forming apparatus of FIG. 1;

FIG. 6 is a diagram for describing an example of the flow of update processing from an application site by the image forming apparatus of FIG. 1;

FIG. 7 is a diagram for describing an example of a flow of update processing from a subscription server by the image forming apparatus of FIG. 1;

FIG. 8 is a diagram for describing an example of an information management file held by the image forming apparatus of FIG. 1;

FIG. 9 is a diagram for describing an example of processing performed by the image forming apparatus of FIG. 1 when the contract type of an application is changed;

FIG. 10 is a diagram for describing an example of an application manual update screen in an application site displayed on the image forming apparatus of FIG. 1;

FIG. 11 is a diagram for describing an example of the flow of application update processing by the image forming apparatus of FIG. 1;

FIG. 12 is a diagram for describing an example of an application manual update screen of an application site in an image forming system;

FIG. 13 is a diagram for describing an example of a flow of automatic uninstallation processing of an application for which a subscription contract is made by an image forming system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An embodiment of an information processing apparatus, an information processing method, and a non-transitory recording medium is described in detail below with reference to the accompanying drawings.

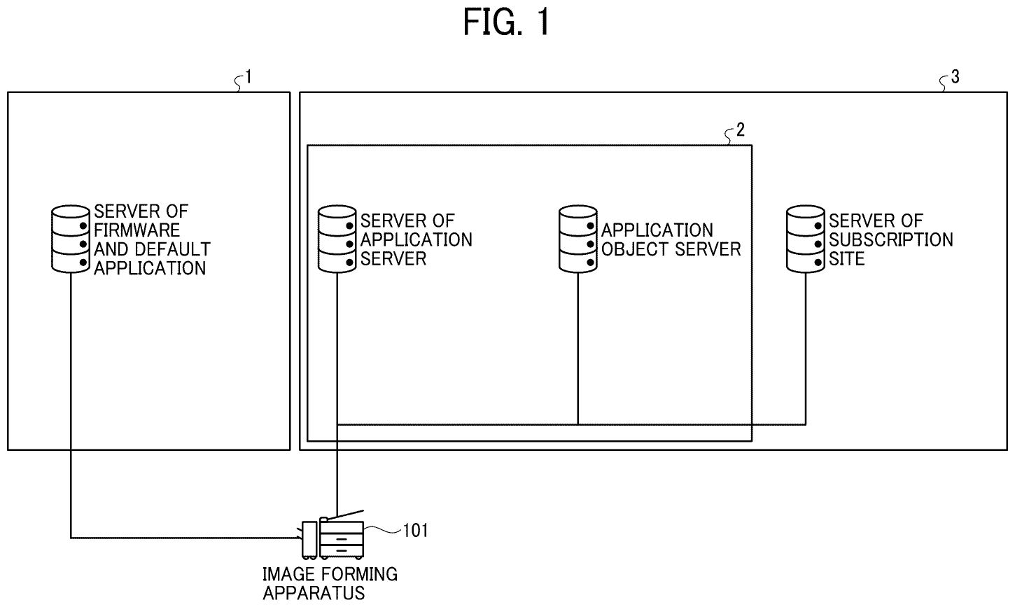

FIG. 1 is a diagram illustrating an example of a relationship between an image forming apparatus and servers according to the present embodiment. Methods for installing an application in an information processing apparatus such as an image forming apparatus are roughly classified into the following four patterns (1) to (4). In the following description, the updates by the methods are described by the expressions in parentheses to simplify the description.

(1) Update from Medium

Installing and updating an application from an external medium. This method is an example of installing means and updating means.

(2) Update from Server in which Firmware and Default Application Reside as Indicated by Reference Numeral 1

Downloading an application as firmware from a server in which firmware and a default application reside and installing and updating the downloaded application. This method is an example of installing means and updating means. The default application is downloaded and updated according to the firmware update schedule.

(3) Update from Application Site as Indicated by Reference Numeral 2

Accessing a server of an application site, purchasing the application, downloading the application from an application object server, and installing and updating the downloaded application. This method is an example of installing means and updating means. The application site is a download site of an application. An application corresponding to a user's task or use can be selected and installed by accessing the application site from a control panel of the image forming apparatus.

Application objects other than the default application reside in the application object server.

(4) Update from Subscription Server as indicated by Reference Numeral 3

Making a subscription contract at a server of a subscription contract site, acquiring application information to be installed and updated by the image forming apparatus accessing the server of the application site, and installing and updating a target application by downloading the target application from an application object server. This method is an example of installing means and updating means. The server of the subscription site manages information of the subscription contract and can receive a request from the server of the application site and send a reply indicating the contract status.

The present embodiment is a technology relating to a mechanism for determining whether to update applications when the applications to be installed and updated by the four methods are the same application.

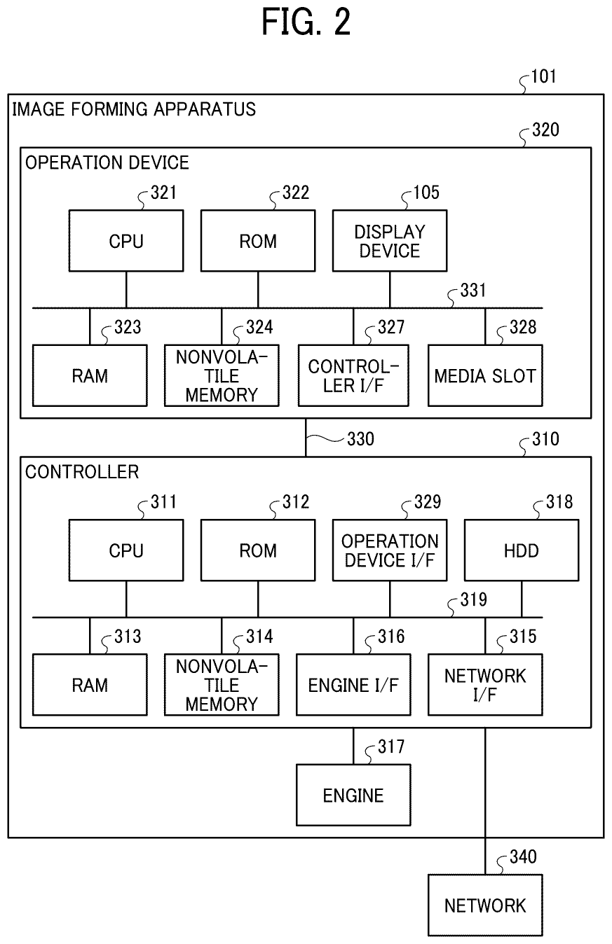

FIG. 2 is a block diagram illustrating an example of the configuration of the image forming apparatus according to the present embodiment.

The image forming apparatus 101 includes a controller 310 that implements various image forming functions such as a copier function, a scanner function, a facsimile function, and a printer function, and an operation device 320 that receives a user operation. Receiving a user operation includes receiving or accepting information or data input according to an operation performed by a user. Such information or data includes, for example, a signal indicating a coordinate value on a screen. The controller 310 and the operation device 320 are communicably connected to each other through a dedicated communication path 330. The communication path 330 may be in compliance with a universal serial bus (USB) standard. However, any suitable standard, regardless of wired or wireless, may be used as the communication path 330.

The controller 310 operates according to an operation received by the operation device 320. Further, the controller 310 can also communicate with an external device such as a client personal computer (PC) and can operate according to an instruction received from the external device.

The hardware configuration of the controller 310 is described below. As illustrated in FIG. 2, the controller 310 includes a central processing unit (CPU) 311, a read-only memory (ROM) 312, a random-access memory (RAM) 313, a nonvolatile memory 314, a network interface (I/F) 315, an engine I/F 316, an operation device I/F 329, a hard disk drive (HDD) 318, and a system bus 319.

The CPU 311 controls the entire operation of the image forming apparatus 101. The CPU 311 controls the entire operation of the image forming apparatus 101 by executing a program stored in, for example, the ROM 312, the nonvolatile memory 314, or the HDD 318 using the RAM 313 as a work area. For example, the CPU 311 controls various functions such as the copier function, the scanner function, the facsimile function, and the printer function described above.

The ROM 312 is, for example, a nonvolatile memory that stores a basic input/output system (BIOS), which is executed when the image forming apparatus 101 is started, and various settings.

The RAM 313 is a volatile memory that is used as, for example, a work area for the CPU 311. The nonvolatile memory 314 is a nonvolatile storage device that stores, for example, an operating system (OS), an application program, and various data and is implemented by, for example, a solid-state drive (SSD).

The network I/F 315 is a network interface that connects the image forming apparatus 101 to the network 340 and enables the image forming apparatus 101 to communicate with an external device connected to the network 340. The engine I/F 316 is an interface for communicating with the engine 317.

The engine 317 is hardware that performs general-purpose processing for implementing the copier function, the scanner function, the facsimile function, and the printer function, except for communication processing. The engine 317 includes, for example, a scanner (image reading device) that scans and reads an image on a document, a plotter that prints an image on a sheet material such as paper, and a facsimile device that performs facsimile communication. The engine 317 may further include optional equipment such as a finisher that sorts printed sheets, and an automatic document feeder (ADF) that automatically feeds documents to be scanned.

The system bus 319 is connected to the above-described components and transfers address signals, data signals, and various control signals.

The hardware configuration of the operation device 320 is described below. As illustrated in FIG. 2, the operation device 320 includes a CPU 321, a ROM 322, and a RAM 323, a nonvolatile memory 324, a controller I/F 327, a media slot 328, a display device 105, and a system bus 331.

The CPU 321 controls the entire operation of the operation device 320. The CPU 321 controls the entire operation of the operation device 320 by executing a program stored in, for example, the ROM 322 or the nonvolatile memory 324 using the RAM 323 as a work area. For example, the CPU 321 implements various functions such as displaying information or an image according to an input received from a user.

The ROM 322 is, for example, a nonvolatile memory that stores a BIOS, which is executed when the operation device 320 is started, and various settings. The RAM 323 is a volatile memory that is used as, for example, a work area for the CPU 321. The nonvolatile memory 324 is, for example, a nonvolatile storage device that stores, for example, an OS, an application program, and various data.

The controller I/F 327 is an interface for communicating with the controller 310 through the communication path 330. The media slot 328 is an interface such as a USB that connects the operation device 320 to an external medium.

The display device 105 receives various inputs in response to a user's operations and displays various information such as information corresponding to the received operation, information indicating the operational status of the image forming apparatus 101, and a setting status. Examples of the display device 105 include, but are not limited to, a liquid crystal display (LCD) having a touch panel function. The display device 105 may be implemented by an organic electroluminescence (EL) display having a touch panel function. In addition to or instead of the above-described display device 105, an operation device such as a hardware key or a display device such as an indicator lamp may be provided.

The system bus 331 is connected to the above-described components and transfers address signals, data signals, and various control signals.

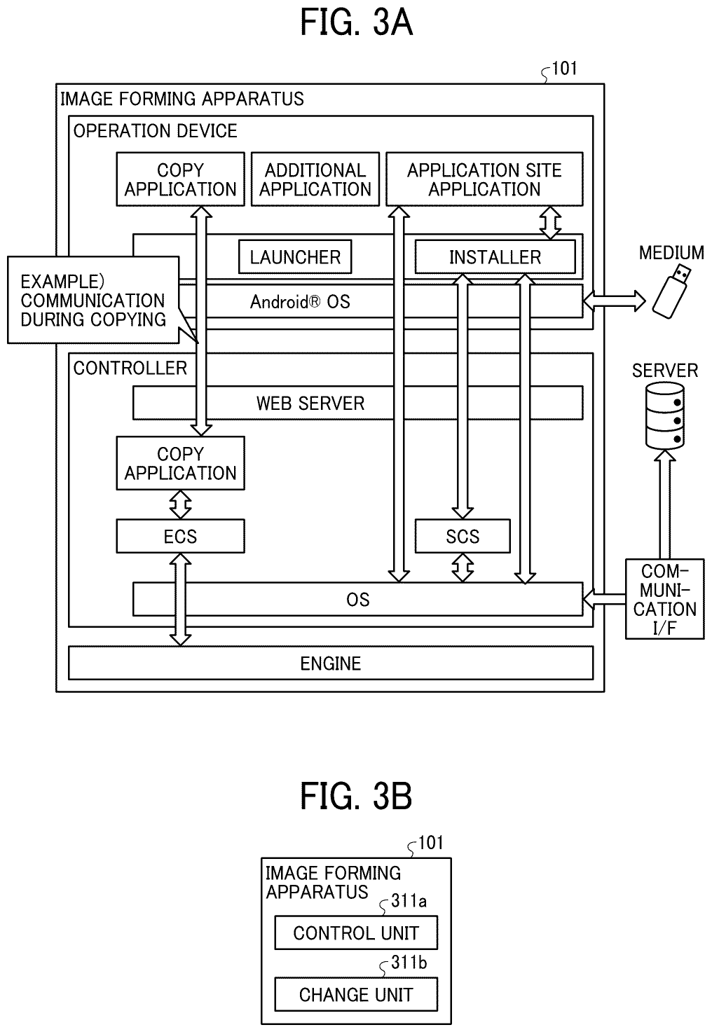

FIG. 3A is a diagram illustrating an example of the software configuration of the image forming apparatus 101 according to the present embodiment. In the present embodiment, in the image forming apparatus 101, the installation and update of an application is performed with an application site, an installer, and a system control service (SCS). The “installer” refers to software used when introducing (installing) an application on a computer. The “SCS” refers to a system control service, which is a module in the controller, and requests the installer to update firmware and a default when updating the firmware and the default application. An application site application in the figure is an application (software) for installing and updating an application from an application site. ECS in the figure indicates an engine control service. In the present embodiment, when the installer is installed in the Android® OS, an additional application is installed, and the update of the application is performed. An object to be installed and updated is acquired by downloading from a server or a medium.

FIG. 3B is a block diagram illustrating an example of the functional configuration of the image forming apparatus 101 according to the present embodiment. In the present embodiment, the CPU 311 of the image forming apparatus 101 executes a program stored in the ROM 312 using the RAM 313 as a work area to implement a control unit 311a and a change unit 311b. In the present embodiment, the image forming apparatus 101 is an example of an information processing apparatus having an automatic application update function.

The control unit 311a stores, in an information management file, additional information that associates installation method information indicating a method by which an application is installed with a contract type of the installed application. The control unit 311a is an example of controlling means. Further, the control unit 311a determines whether to update the application with an update method by referring to the installation method information and the contract type when updating the application.

By managing the installation method information and the contract type of the installed application in one information management file as described above, the image forming apparatus 101 can correctly determine whether to update the application, even when the mechanism of updating the application is the same, without depending on mechanisms of updating the application. As a result, even when an application installable by the mechanisms of the different installation methods is shared, the application can be updated to versions released by the mechanisms of the installation methods. This prevents the application from being updated to an unintended version.

Further, the control unit 311a refers to the contract type to uninstall an application for which a contract has expired.

The change unit 311b changes the contract type of an application. The change unit 311b is an example of changing means. When the contract type is changed, the control unit 311a updates and uninstalls an application based on the installation method information and the contract type.

Further, when an application is selected on an application update screen that displays one or more update targets to be manually updated for applications on the application site, the control unit 311a updates the selected application. The application update screen is an example of an update target selection screen. The control unit 311a determines that an application for which a subscription contract is made is to be updated automatically and an automatic update is not to be performed for the application. Accordingly, the control unit 311a does not display such an application on the application update screen. The control unit 311a displays an application for which a contract of one-time purchase is made and an installation method is installation from an application site or installation from a subscription contract server on the application update screen as an application that can be updated manually.

When an application to be uninstalled is selected on an uninstallation screen with respect to an application on the application site, the control unit 311a uninstalls the selected application. The uninstallation screen is a screen for manually uninstalling an application. The control unit 311a only automatically uninstalls an application for which a subscription contract is made when the contract expires and does not manually uninstall such an application. The control unit 311a displays an application for which a contract type is one-time purchase is made and an installation method is installation from an application site or installation from a subscription server on the uninstallation screen as an application that can be uninstalled. The control unit 311a does not display an application of which the contract type is a subscription contract on the uninstallation screen.

The control unit 311a automatically uninstalls the application of which the contract type is a subscription contract when the contract expires but does not automatically uninstall the application of which the contract type is a subscription contract when the installation method is the installation from the application site.

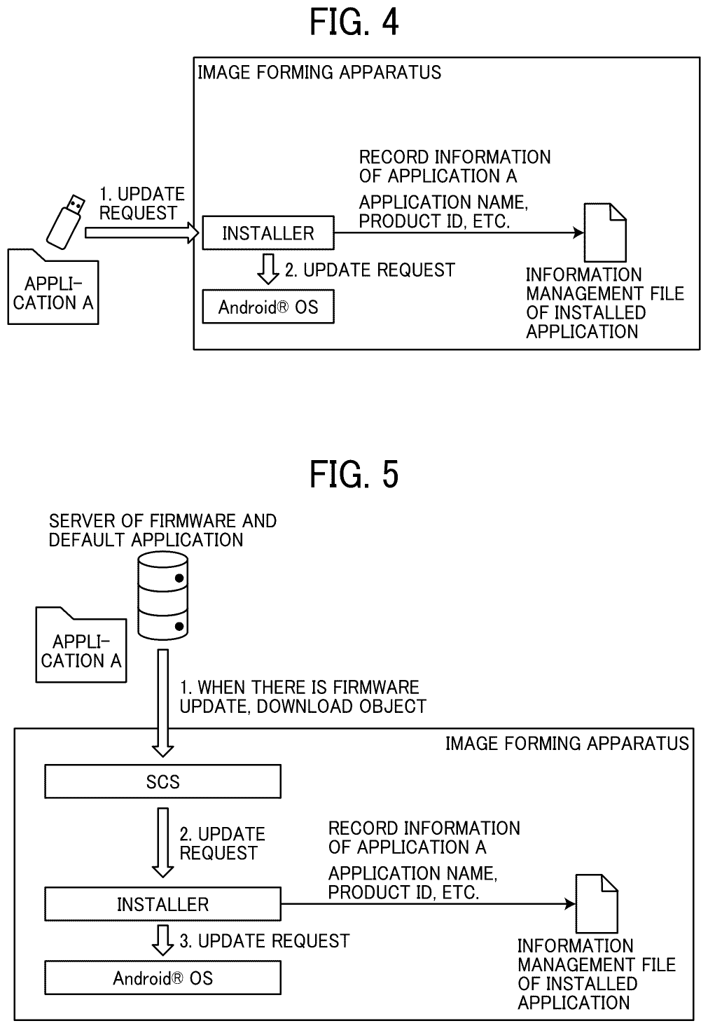

An example of the flow of application update processing performed by the image forming apparatus 101 according to the present embodiment is described below with reference to FIG. 4 to FIG. 7. FIG. 4 is a diagram for describing an example of a flow of the above-described pattern (1), i.e., update processing from a medium by the image forming apparatus 101 according to the present embodiment. In response to receiving an update request for an application (e.g., Application A) from a medium, the installer requests the OS to update the application. Subsequently, the installer records information (application information) about the application such as an application name and a product identifier (ID).

FIG. 5 is a diagram for describing an example of a flow of the above-described pattern (2), i.e., updating firmware and a default application from a server by the image forming apparatus 101 according to the present embodiment. First, when an application such as firmware and a default application is updated in a server of the application, the SCS downloads an object and requests the installer to update the application. Subsequently, the installer requests the OS to update the application. Subsequently, the installer records the application information of the application such as an application name and a product ID.

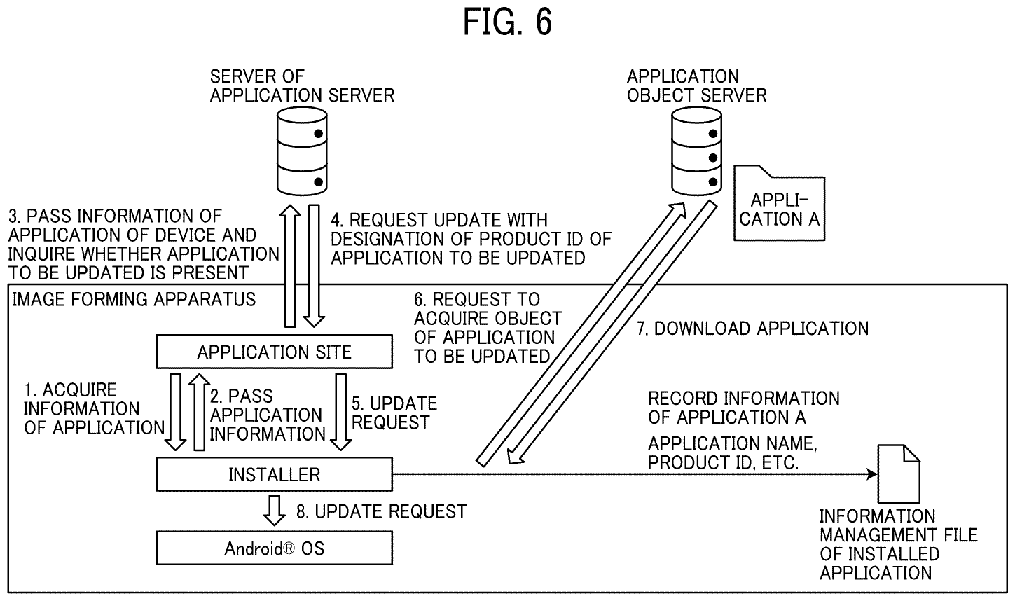

FIG. 6 is a diagram for describing an example of the flow of the above-described patten (3), i.e., update processing from an application site by the image forming apparatus 101 according to the present embodiment. First, the installer acquires application information from the application site. The “application site” in the figure is an application site application. The application site application can display a screen of a website on the display device of the image forming apparatus 101, request the installer to update, and transmit and receive information (data) to and from an external server. Subsequently, the installer provides the application site with information (device application information) about an application installed in the image forming apparatus 101, among the acquired application information. The application site transfers the device application information to the server of the application site and inquires whether an application to be updated is present.

The server of the application site requests the application site to update the application to be updated with designation of the product ID of the application to be updated. The application site requests the installer to update the application associated with the designated product ID. The installer requests a server (application object server) of an object of an application to acquire an object of the application to be updated. Subsequently, the installer downloads the object of the application to be updated from the server. Subsequently, the installer requests the OS to update the application. Subsequently, the installer records the application information of the application such as an application name and a product ID.

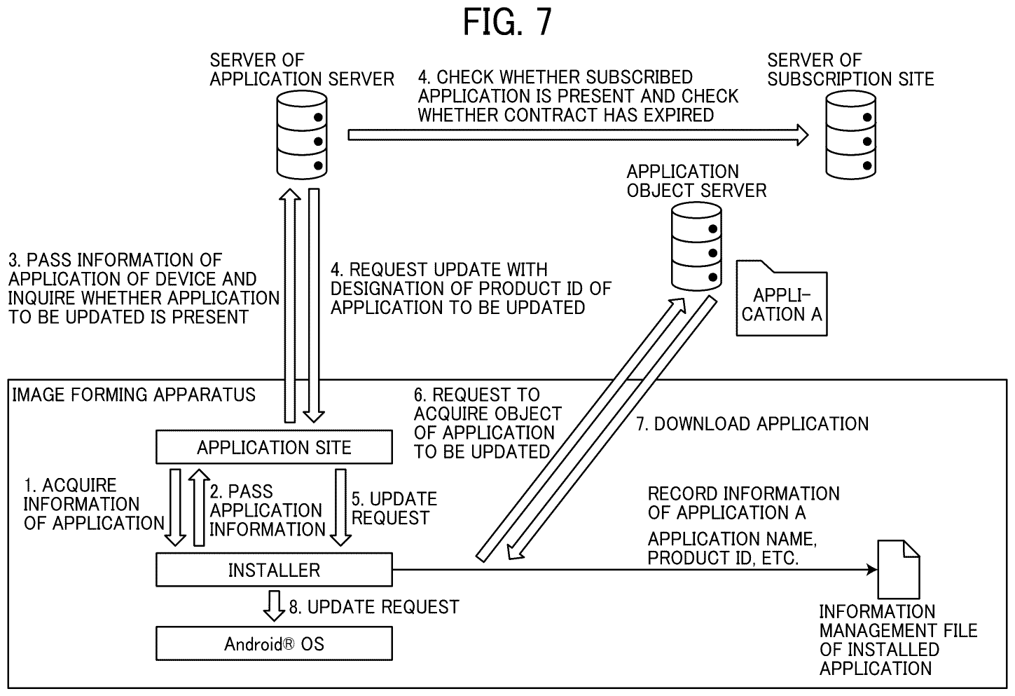

FIG. 7 is a diagram for describing an example of a flow of the above-described pattern (4), i.e., update processing from a subscription server by the image forming apparatus 101 according to the present embodiment. First, the installer acquires application information from the application site. Subsequently, the installer provides the application site with information (device application information) about an application installed in the image forming apparatus 101, among the acquired application information. The application site provides the server of the application site with the device application information. The application site server transmits the device application information to the server (subscription server) of the subscription contract site to check whether applications installed in the image forming apparatus 101 include an application for which a subscription contract is made is and whether the contract for the application has expired.

Subsequently, the server of the application site requests the application site to update the application to be updated with designation of the product ID of the application to be updated. The application site requests the installer to update the application associated with the designated product ID. The installer requests the application object server to acquire an object of the application to be updated. Subsequently, the installer downloads the object of the application to be updated from the server. Subsequently, the installer requests the OS to update the application. Subsequently, the installer records the application information of the application such as an application name and a product ID.

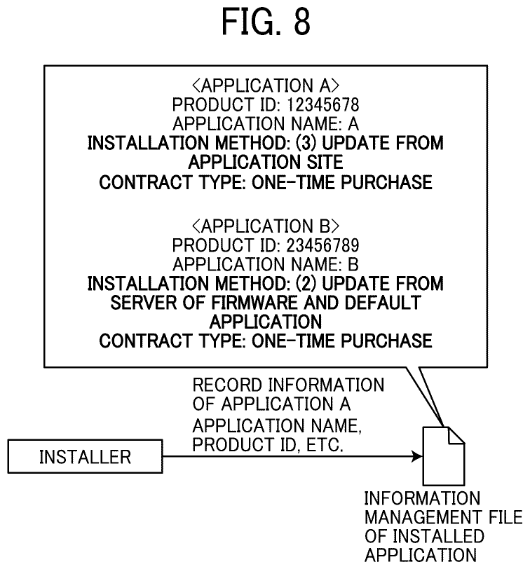

FIG. 8 is a diagram for describing an example of an information management file held by the image forming apparatus 101 according to the present embodiment. In the updates of the above-described pattern (1) to (4), in a case where the same application (e.g., Application A) is present in the servers, updating by the update functions of the methods of the patterns (1) to (4) causes an unintended update in a case where the versions of Application A are different. Further, since whether to update each application varies depending on the installation method of each application, the control unit 311a controls the update of each application. However, regarding the update from a medium of the pattern (1), a use case is that a service performs the update when an abnormality occurs in an application installed in the image forming apparatus 101, and thus the update of the pattern (1) is permitted for any application. Accordingly, in the present embodiment, the control unit 311a controls whether to permit the update of an application for the pattern (2), i.e., the update of firmware and a default application from a server, for the pattern (3), i.e., the update from the application site, and for the pattern (4), i.e., the update from the subscription contract server.

The control unit 311a determines whether to permit the update of an application according to the following conditions A to C.
Condition A: An application is updated in the same method by which the application is installed, and the application is not updated by any methods other than the method used for the installation. However, the update from the application site of the pattern (3) and the update from the subscription contract server of the pattern (4) are the same in that the update is from the application object server, and thus the control unit 311a may determine the updates by the methods of the pattern (3) and (4) are updates by the same installation method. In other words, updates from a server are classified into two patterns, i.e., the update from the server of the firmware and the default application of the pattern (2) and the update from the application object server of the patterns (3) and (4).
Condition B: Regarding an application for which a subscription contract is made, the application is always updated according to the subscription contract server regardless of the installation method by which the application is installed.
Condition C: Regarding an application for which a subscription contract is made, the application is uninstalled when the contract expires so that the application cannot be used. Accordingly, when the contract expires at the time of update, automatic uninstallation is performed.

To determine whether to update an application according to the above-described conditions at the time of update, the information management file of all the installed applications (device application information) managed by the installer has, for each application, additional information such as an installation method (e.g., application site, firmware update) and the type of contract of the application (e.g., one-time purchase) as illustrated in FIG. 8.

The additional information indicated in Table 1 below is set in the information management file managed by the installer at the time of installation by each of the installation methods described above with reference to FIG. 3 to FIG. 7. The control unit 311a inquires of the subscription contract server of the current contract type. When the inquiry result indicates that a subscription contract is made for an application, the current contract type is updated together with an update request.

TABLE 1

| Additional | | |
|---|---|---|
| Information | Value | Description |
| Installation Method | (1) Medium | Application installed from a medium |
| | (2) Firmware | Application installed as a default |
| | | application |
| | (3) Application Site | Application installed from an application |
| | | site |
| | (4) Subscription | Application installed from a subscription |
| | Server | server |
| Current Contract | One-time Purchase | The contract type of an application other |
| Type | | than a subscription application below is |
| | | one-time purchase. |
| | Subscription | The contract type of an application for |
| | | which a subscription contract is currently |
| | | valid is subscription. |
| | | If a certain application was installed from |
| | | an application site and thereafter a |
| | | subscription contract is made for the |
| | | certain application, the contract type of |
| | | the certain application is subscription. |

Table 2 below is a table summarizing the control of the update of an application based on the relation between the combination of the parameter combinations (i.e., the installation method and the current contract type) and the conditions A to C.

In the present embodiment, the control unit 311a determines whether the update of the application is permitted using the above Table 1 and Table 2 below.

TABLE 2

| | | Installation Method | | | |
|---|---|---|---|---|---|
| | | | | (3) | (4) |
| | | | | Application | Subscription |
| | | (1) Medium | (2) Firmware | Site | Server |
| Current | One-time | Firm Update: | Firm Update: | Firm Update: | Firm Update: |
| Contract | Purchase | Update is | Update is | Update is not | Update is not |
| Type | | permitted | permitted | permitted | permitted |
| | | Application | Application | Application | Application |
| | | Server | Server | Server | Server |
| | | Update: | Update: | Update: | Update: |
| | | Update is not | Update is not | Update is | Update is |
| | | permitted | permitted | permitted | permitted |
| | Subscription | Firm Update: | Firm Update: | Firm Update: | Firm Update: |
| | | Update is not | Update is not | Update is not | Update is not |
| | | permitted | permitted | permitted | permitted |
| | | Application | Application | Application | Application |
| | | Server | Server | Server | Server |
| | | Update: | Update: | Update: | Update: |
| | | Update is | Update is | Update is | Update is |
| | | permitted | permitted | permitted | permitted |
| | | Automatic | Automatic | Automatic | Automatic |
| | | Uninstallation: | Uninstallation: | Uninstallation: | Uninstallation: |
| | | Not permitted | Not permitted | Not permitted | Permitted |

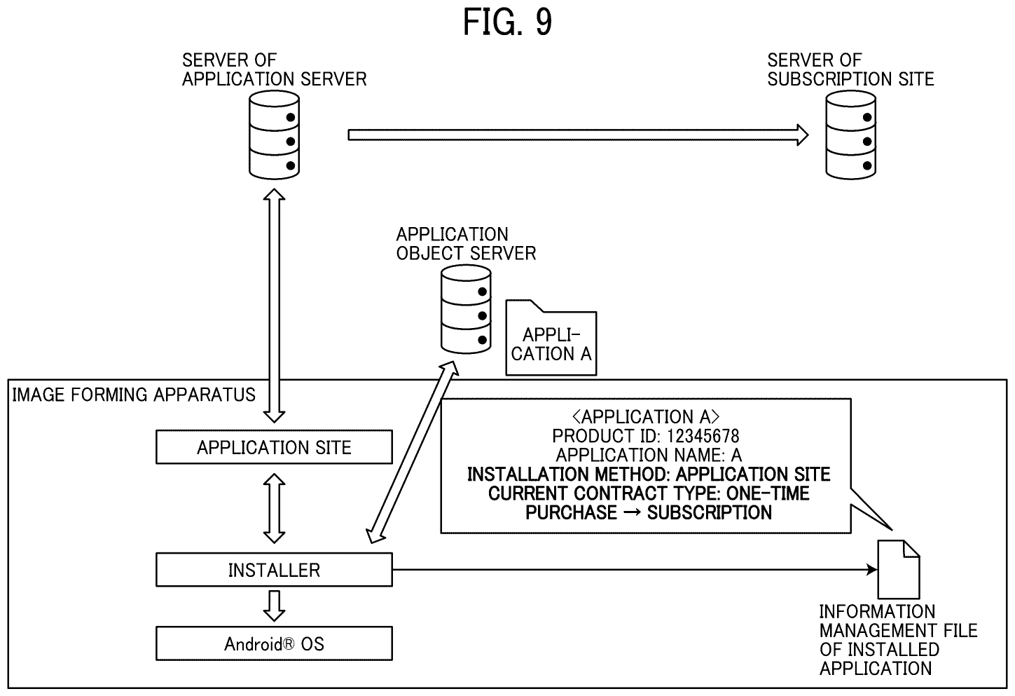

FIG. 9 is a diagram for describing an example of processing performed by the image forming apparatus 101 when the contract type of an application is changed according to the present embodiment. In the present embodiment, as described above, the control unit 311a manages the current contract type and the installation method in association with each other in the information management file as described above. With this configuration, even when an application is purchased and installed as a one-time purchase from the application site and thereafter a subscription contract is made for the application, the application is prevented from being automatically uninstalled when the contract expires. This is because once an application has been purchased, it is detrimental to a user if the application is deleted without the user's consent.

For example, there is a case where, while an application (e.g., Application A) that is purchased from an application site is in use, a subscription package of another product is contracted, and the application A is included in the subscription package. In this case, although Application A is updated continuously as an application for which the subscription contract is made, the uninstallation of Application A should be prevented when the contract expires. Therefore, in the present embodiment, the control unit 311a manages two items, i.e., the current contract type and the installation method in association with each other in the information management file, and thus, even when the application A is purchased and installed as a one-time purchase from the application site and thereafter a subscription contract is made for Application A is made, the control unit 311a does not uninstall Application A when the contract expires. In other words, in Table 2, when the “installation method” is “(3) application site” and the “current contract type” is changed from “one-time purchase” to “subscription,” the control unit 311a performs control to set automatic uninstallation to “not permitted.”

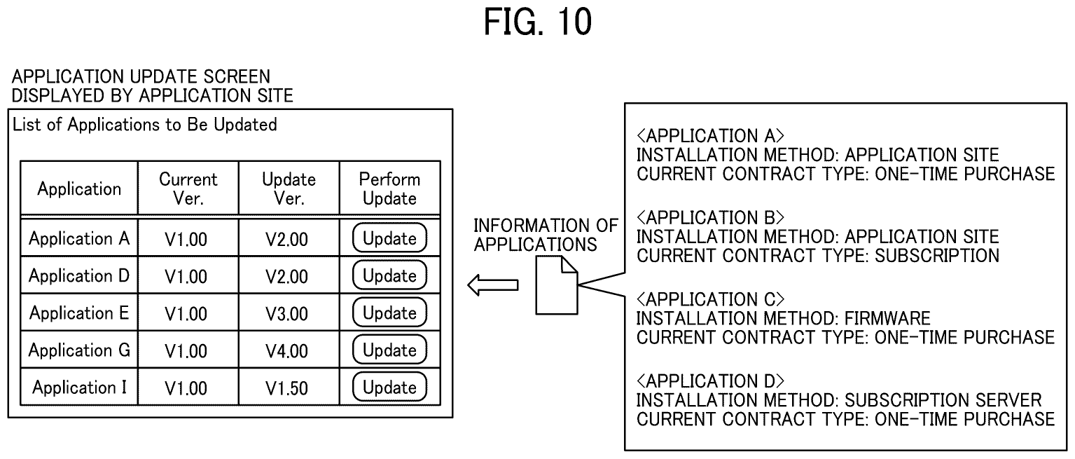

FIG. 10 is a diagram for describing an example of an application manual update screen in an application site displayed on the image forming apparatus 101 according to the present embodiment. In the present embodiment, the control unit 311a can control whether the manual update of an application is to be permitted by using the two parameters (i.e., the installation method and the current contract type). Screens of the application site include the application update screen (update target selection screen) that allows a user to select a desired application and manually perform the update of the selected application as described below.

Applications to be displayed on the application update screen as update targets can be limited to applications of which the contact type is one-time purchase and of which the installation method is installation from the server of the application site or installation from the subscription contract server. Further, since an application for which the subscription contract is made supports only automatic update as not permitting manual update, the application for which the subscription contract is made may be excluded from application to be displayed on the application update screen. An application of which contract is changed from a subscription to a one-time purchase may also be displayed as applications to be updated.

The above-described processing can be performed for manual uninstallation in the substantially the same manner as the update.

Screens of the application site preliminarily include a screen for manual uninstallation, and applications to be deleted can be displayed in the same logic as that for the update.

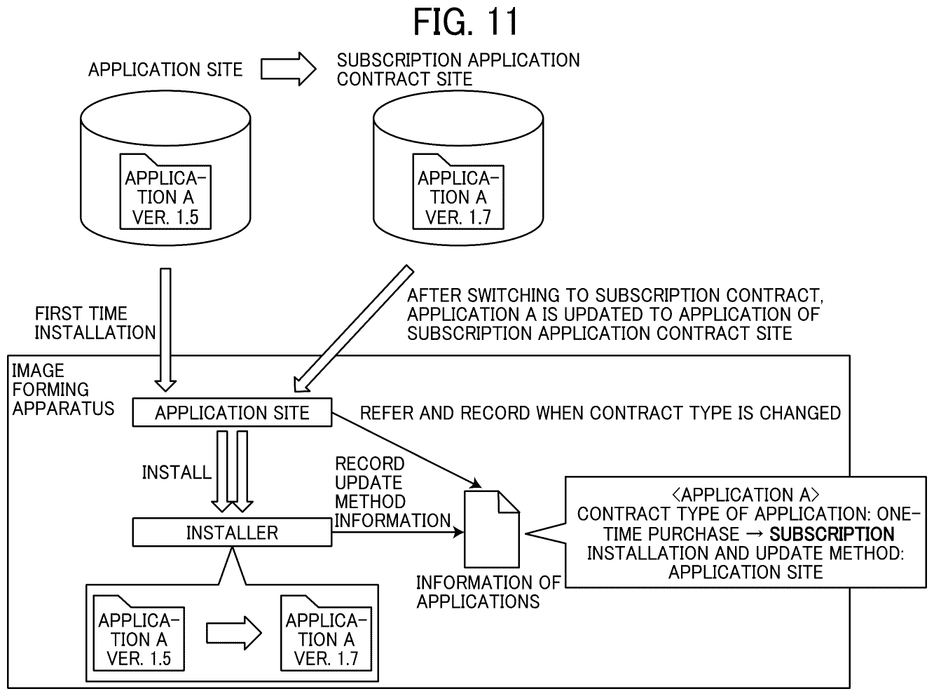

FIG. 11 is a diagram for describing an example of the flow of application update processing by the image forming apparatus 101 according to the present embodiment. As described above, since the image forming apparatus 101 has information about the contract type for each application, even when the contract type of an application is changed from the application site to the subscription contract or from the subscription contract to the application site, the image forming apparatus 101 can accurately determine an application to be updated and update the determined application. As illustrated in FIG. 11, even when the contract type of an application is changed midway, the image forming apparatus 101 only changes the contract type of the application in the information management file, thereby when updating the application, the image forming apparatus 101 checks the contract site of the application for which a subscription contract is made and updates the application according to the check result. An example illustrated FIG. 11 is described below. When Application A is installed, the version 1.5 is installed from the application site. When the contract type of Application A is changed from the application site to the subscription contract, information about the contract type of Application A managed by the information management file is changed to the subscription. When updating Application A, the image forming apparatus 101 refers to the information management file, installs the version 1.7, which is the updated version, from the subscription application contract site, and performs the update.

There are two ways for updating an application. One is that an apparatus automatically updates the application, the other is that a user selects a desired application to be updated on a screen and updates the selected application. On a screen (the application update screen) that allows a user to select a desired application to be updated, a version to which the application is to be updated corresponding to each installation method is displayed by using two pieces of information, i.e., a contract type and an installation (update) method of the application.

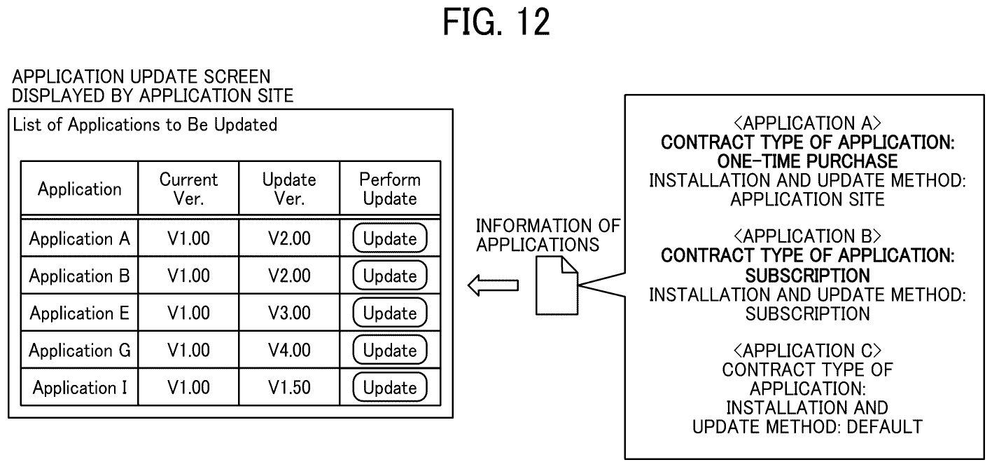

FIG. 12 is a diagram for describing an example of an application manual update screen of an application site in the image forming apparatus 101 according to the present embodiment. Module (Md) of the application site includes an application update screen that displays a list of applications that can be updated. When displaying the applications that can be updated, the control unit 311a refers to the contract types and the installation (update) methods associated with applications installed in the image forming apparatus 101. Accordingly, the control unit 311a hides applications of which the installation (update) method is the pattern (1), i.e., an update from a medium or the pattern (2), i.e., an update from the server of the firmware and the default application and displays only applications of which the contract type is one-time purchase or subscription as applications to be updated. Thus, an application of which the contract type is changed to one-time purchase can be set to an update target as an application acquired from the application site.

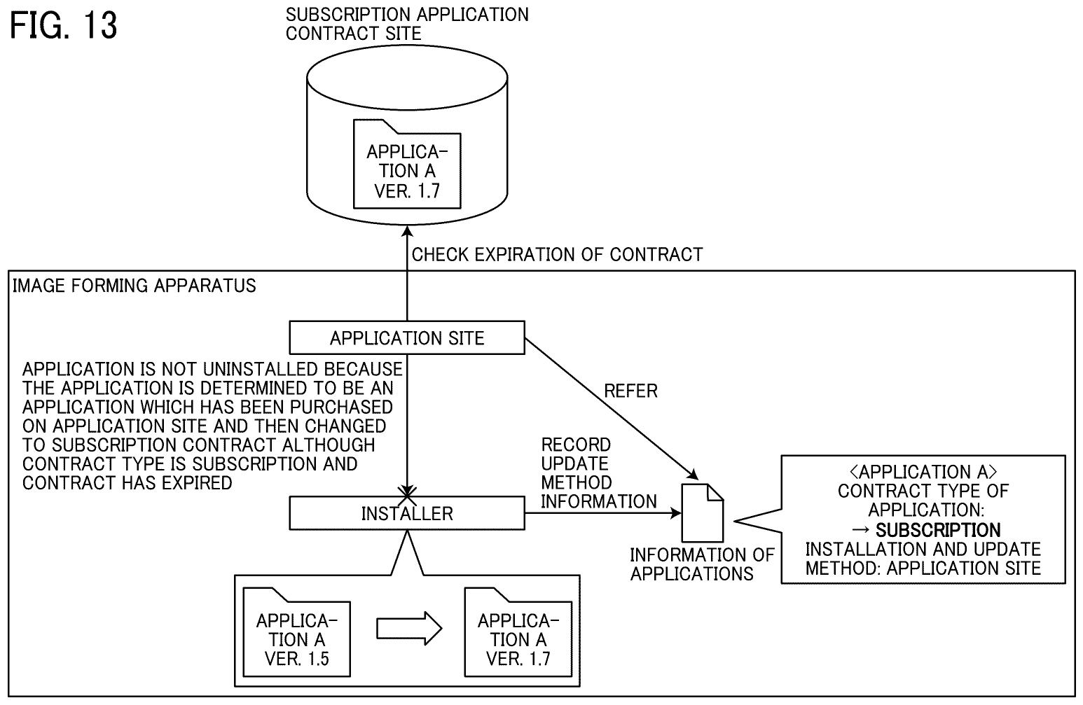

FIG. 13 is a diagram for describing an example of a flow of automatic uninstallation processing of an application for which a subscription contract is made by the image forming apparatus 101 according to the present embodiment. Regarding the uninstallation of an application of which the contract type is a subscription, an automatic uninstallation function is provided to prevent an application for which the contract is expired from being used. However, when an application of which the contract type is changed to a subscription contract after the application is purchased from an application site and installed, it is not appropriate to uninstall such an application only according to the current contract type because the application was purchased in the past. Therefore, in the present embodiment, the control unit 311a appropriately selects an application to be automatically uninstalled by referring to not only the contract type but also the installation (update) method.

As described above, by managing the installation method information and the contract type of the installed application in one information management file, the image forming apparatus 101 according to the present embodiment can correctly determine whether to update the application, even when the mechanism of updating the application is the same, without depending on mechanisms of updating the application. As a result, even when an application installable by different mechanisms of different installation methods is shared, the application can be updated to versions released by the mechanisms of the installation methods. This prevents the application from being updated to an unintended version.

A program executed by the image forming apparatus 101 according to the present embodiment is preinstalled and provided in, for example, the ROM 312. The program executed by the image forming apparatus 101 according to the present embodiment may be stored in a computer-readable recording medium, such as a compact disc read-only memory (CD-ROM), a flexible disk (FD), a compact disc-recordable (CD-R), and a digital versatile disk (DVD), in an installable or executable file format, to be provided.

Alternatively or additionally, the program executed by the image forming apparatus 101 according to the present embodiment is stored in a computer connected to a network such as the Internet and downloaded through the network, thus being providable. Alternatively or additionally, the program executed by the image forming apparatus 101 according to the present embodiment is provided or distributed via a network such as the Internet.

The program executed by the image forming apparatus 101 according to the present embodiment has a module configuration including the above-described units (the control unit 311a and the change unit 311b). In terms of actual hardware, a processor such as the CPU 311 reads the program from the ROM 312 and executes the program. Thus, the units are loaded onto a main memory, and the control unit 311a and the change unit 311b are generated on the main memory.

The functionality of the elements disclosed herein may be implemented using circuitry or processing circuitry which includes general purpose processors, special purpose processors, integrated circuits, application-specific integrated circuits (ASICs), digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA, ASIC or DSP.

The information processing apparatus is not limited to the image forming apparatus 101 provided that the apparatus has a communication function. The information processing apparatus may be, for example, a projector, an interactive whiteboard (IWB; an electronic whiteboard having a blackboard function to enable mutual communication), an output device such as digital signage, a head-up display (HUD) device, an industrial machine, an image-capturing device, a sound collecting device, a medical device, a networked home appliance, an automobile (connected car), a laptop PC, a mobile phone, a smartphone, a tablet communication terminal, a game console, a personal digital assistant (PDA), a digital camera, a wearable PC, or a desktop PC.

The configuration according to the related art has a problem when an installable application is shared by different installation mechanisms, that is, when the same application can be installed by multiple installation mechanisms. In other words, when the application is updated by different update methods provided for respective installation mechanisms, the update is performed at an unintended timing, or when versions released by the respective mechanisms are different, an unintended version upgrade or downgrade may occur.

According to one aspect of the present disclosure, even when an application installable by different installation mechanisms is shared, the application can be updated to a version released by each of the installation mechanisms.

Aspects of the present disclosure are, for example, as follows.

### Aspect 1

According to Aspect 1, an information processing apparatus has an automatic update function for an application.

The information processing apparatus includes installing means for installing an application.

The information processing apparatus includes updating means for updating the application.

The information processing apparatus includes controlling means for holding installing means information indicating the installing means that has installed the application and a contract type of the installed application in association with each other and determining whether the application is permitted to be updated by the updating means by referring to the installing means information and the contract type at a time of update of the application.

### Aspect 2

According to Aspect 2, in the information processing apparatus of Aspect 1, the controlling means refers to the contract type to uninstall the application for which a contract has expired.

### Aspect 3

According to Aspect 3, the information processing apparatus of Aspect 1 or 2 includes changing means for changing the contract type of the application.

The controlling means updates and uninstalls the application based on the installing means and the contract type when the contract type is changed.

### Aspect 4

According to Aspect 4, in the information processing apparatus of any one of Aspects 1 to 3, when the application is selected on an update target selection screen that displays an update target to be manually updated for the application on an application site, the controlling means updates the selected application, and the controlling means displays the application of which the contract type is a one-time purchase and of which the installing means is installation from the application site or installation from a subscription server on the update target selection screen.

### Aspect 5

According to Aspect 5, in the information processing apparatus of Aspect 4, the controlling means does not display the application of which the contract type is a subscription contract on the update target selection screen.

### Aspect 6

According to Aspect 6, in the information processing apparatus of any one of Aspects 1 to 5, when the application to be uninstalled is selected on an uninstallation screen for manually uninstalling the application for the application on an application site, the controlling means uninstalls the selected application.

The controlling means only automatically uninstalls an application for which a subscription contract is made when the subscription contract expires and does not manually uninstall the application for which the subscription contract is made.

The controlling means displays the application of which the contract type is a one-time purchase and of which the installing means is installation from the application site or installation from a subscription server on the uninstallation screen.

### Aspect 7

According to Aspect 7, in the information processing apparatus of Aspect 6, the controlling means does not display the application of which the contract type is a subscription contract on the uninstallation screen.

### Aspect 8

According to Aspect 8, in the information processing apparatus of any one of Aspects 1 to 7, the controlling means automatically uninstalls the application of which the contract type is a subscription contract when the subscription contract expires.

The controlling means does not automatically uninstall the application of which the installing means is installation from an application site even when the contract type is a subscription contract.

### Aspect 9

According to Aspect 9, an information processing method performed by an information processing apparatus having an automatic application update function includes installing an application, updating the application, and holding installing means information indicating installing means that has installed the application and a contract type of the installed application in association with each other, and determining whether the application is permitted to be updated by updating means by referring to the installing means information and the contract type at a time of update of the application.

### Aspect 10

According to Aspect 10, a program causes a computer that controls an information processing apparatus having an automatic application update function to perform a method including installing an application, updating the application, and holding installing means information indicating installing means that has installed the application and a contract type of the installed application in association with each other, and determining whether the application is permitted to be updated by updating means by referring to the installing means information and the contract type at a time of update of the application.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising circuitry configured to:
install an application;
store, in a memory, installation method information indicating an installation method with which the application is installed in association with a contract type of the application;
refer to the installation method information and the contract type to determine whether the application is permitted to be updated at a time of updating the application; and
control update of the application according to a determination result.

2. The information processing apparatus according to claim 1, wherein
the circuitry refers to the contract type to uninstall the application for which a contract has expired.

3. The information processing apparatus according to claim 1, wherein the circuitry is further configured to:
change the contract type of the application; and
update and uninstall the application based on the installation method information and the contract type when the contract type is changed.

4. The information processing apparatus according to claim 1, wherein
when the application is selected on an update target selection screen, the circuitry updates the selected application, the update target selection screen displaying an update target application to be manually updated on an application site and displaying the application of which the contract type is a one-time purchase and of which the installing method is installation from the application site or installation from a subscription server.

5. The information processing apparatus according to claim 4, wherein
the circuitry excludes the application of which the contract type is a subscription contract from being displayed on the update target selection screen.

6. The information processing apparatus according to claim 1, wherein
when the application is selected on an uninstallation screen, the circuitry uninstalls the selected application, the uninstallation screen being a screen for manually uninstalling an application on an application site and displaying the application of which the contract type is a one-time purchase and of which the installation method is installation from the application site or installation from a subscription server, and
the circuitry automatically uninstalls the application for which a subscription contract is made only when the subscription contract expires.

7. The information processing apparatus according to claim 6, wherein
the circuitry excludes the application of which the contract type is a subscription contract from being displayed on the uninstallation screen.

8. The information processing apparatus according to claim 1, wherein
the circuitry is configured to automatically uninstall the application of which the contract type is a subscription contract when the subscription contract expires, and
in a case where the installation method is installation from an application site, the circuitry does not automatically uninstall the application even when the contract type is a subscription contract.

9. An information processing method comprising:
installing an application on an information processing apparatus;
storing, in a memory, installation method information indicating an installation method with which the application is installed in association with a contract type of the application;
referring to the installation method information and the contract type to determine whether the application is permitted to be updated at a time of updating the application; and
controlling update of the application according to a determination result.

10. A non-transitory recording medium storing a plurality of program codes which, when executed by a computer, causes the computer to perform a method comprising:
installing an application on an information processing apparatus;
storing, in a memory, installation method information indicating an installation method with which the application is installed in association with a contract type of the application;
referring to the installation method information and the contract type to determine whether the application is permitted to be updated at a time of updating the application; and
controlling update of the application according to a determination result.
